(19) United States
(12) Patent Application Publication
(10) Pub. No.: US 2012/0221965 A1
(43) Pub. Date: Aug. 30, 2012

(54) Discussion Enlivenment Assistance Device, Discussion Enlivenment Assistance Method, and Computer Program Therefore

(75) Inventors: Tomoya Takeyoshi, Fujimino-shi (JP); Keiichiro Hoashi, Fujimino-shi (JP); Chihiro Ono, Fujimino-shi (JP)

(73) Assignee: KDDI Corpoation

(21) Appl. No.: 13/402,163

(22) Filed: Feb. 22, 2012

(30) Foreign Application Priority Data
Feb. 25, 2011 (JP) 2011-040692

(51) Int. Cl. G06F 3/01; G06F 15/16

(52) U.S. Cl. 715/753

(57) ABSTRACT

A discussion enlivenment assistance device includes: a state visualization unit which generates discussion state data displaying index values indicating a state of each discussion site; a user characteristic presentation unit which generates participating user characteristic data in relation to users participating in a discussion site specified by a user, the participating user characteristic data displaying index values indicating profiles of the users in a discussion; a user control unit which generates invitation nominated user data displaying an invitation nominated user appropriate for the discussion site specified by the user; and a display unit which displays the discussion state data, the participating user characteristic data, and the invitation nominated user data.

### BACKGROUND OF THE INVENTION

1. Field of the Invention

The present invention relates to a discussion enlivenment assistance device, a discussion enlivenment assistance method, and a computer program for discussion enlivenment assistance.

Priority is claimed on Japanese Patent Application No. 2011-040692, filed Feb. 25, 2011, the content of which is incorporated herein by reference.

2. Description of Related Art

In recent years, online discussion sites such as electronic bulletin boards and SNS (social networking services) publicly available on the Internet allow general users to easily perform a discussion on a topic with each other. It is essentially free to generate a new discussion site (for example, to create a new thread on an electronic bulletin board), and to speak on a discussion site (for example, to post one's opinion in text format on a thread on an electronic bulletin board).

There is known a related technology for enlivening a discussion in this type of discussion site. For example, Japanese Unexamined Patent Application, First Publication No. 2002-140323 (hereunder, referred to as Patent Document 1) discloses a related technology as follows. Members of a user group having a discussion on a certain discussion topic are presented with comments and documents registered to the user group. Users other than the members of the user group are presented with documents preliminarily set as being allowed to be presented to users other than the members of the user group. Moreover, as a registration destination of a comment, a user group for which comments or documents the most similar to the content of the comment or to the contents of the comment or a document associated thereto are registered, is searched and presented according to a request from a user.

Moreover, “A Method for Quantifiying Soundness of Online Discussion Using Surface Features”, Tomoya Takeyoshi, Keiichiro Hoashi, Kazunori Matsumoto, Chihiro Ono, WebDB Forum 2010, 1B-3, 2010 (hereunder, referred to as Non-Patent Document 1) discloses a related technology as follows. Based on surface characteristic quantities, such as the number of statements, the number of participating users, statement similarity, statement interval time, and the number of words and frequency of appeared verb conjugations in statement contents, obtained from data of a discussion, there is calculated a value (health degree) which enables to determine whether the discussion is in smooth progress or is in conflict. That is, a health degree is calculated to determine whether or not flaming occurs.

Furthermore, “A Visualization System for Making Choice of Electronic Bulletin Board System”, Michiko Abe, Kiwamu Sato, Naohito Ogasawara, Hiroshi Nunokawa, Shoichi Noguchi, Journal of IEICE (The Institute of Electronics Information and Communication Engineers), Vol. J85-D-1, No. 7, pp. 653-661, 2002 (hereunder, referred to as Non-Patent Document 2) discloses a related technology as follows. A triangle is generated and presented where a period of a thread on an electronic bulletin board (period between the thread operation commencement and the latest submission) is taken as the base thereof and a thread quantity (total size quantity of text submitted to the thread) is taken as the height thereof, to thereby facilitate determination of the level of discussion activeness on the thread. Moreover, regarding a submitter (poster) who participates in a thread, there is generated and presented a triangle where the submission period (period between the time of first submission and the time of the latest submission) is taken as the base of the triangle and the number of submissions and the reply structure thereof are taken as the height of the triangle, to thereby facilitate determination of the characteristic of the thread participant.

However, there are problems in the above related technologies as described below.

(Problem 1) When a large number of sites with discussions being carried out (for example, a large number of threads on an electronic bulletin board) are present, it is difficult for a user to easily find a discussion site which is in an active state without being in conflict.

(Problem 2) It is difficult to reduce the level of psychological burden for a user to make a statement on a discussion site.

(Problem 3) It is difficult to invite, to a discussion site in which a user participates, another appropriate user who has potential to make a contribution to the discussion.

By solving these problems, discussion enlivenment is expected to be achieved.

The related technology disclosed in Patent Document 1 is based on the similarity in text between a search request (keyword) input by a user and the content of a discussion, it is not possible, with respect to Problem 1, to determine whether the discussion is active without being in conflict. Moreover, with respect to Problem 3, it is not possible to identify an appropriate user who has potential to make a contribution to the discussion topic. Furthermore, Problem 2 is not considered.

In the related technology disclosed in Non-Patent Document 1, with respect to Problem 1, it is not possible to search a discussion based on a discussion state of whether the discussion is active or inactive. Furthermore, Problem 2 and Problem 3 are not considered.

In the related technology disclosed in Non-Patent Document 2, with respect to Problem 1, it is not possible to determine whether a discussion is active without being in conflict. Moreover, with respect to Problem 2, regarding a submitter who participates in a thread, it is possible to identify a relationship between the submission period, the number of submissions, and the reply structure thereof. However, it is not possible to identify whether or not this submitter is appropriate for the thread, and it is insufficient to reduce the level of user's psychological burden. Furthermore, Problem 3 is not considered.

### SUMMARY OF THE INVENTION

The present invention takes into consideration the above circumstances, with an object of providing a discussion enlivenment assistance device, a discussion enlivenment assistance method, and a computer program capable of contributing to discussion enlivenment.

A discussion enlivenment assistance device according to the present invention includes: a state visualization unit which generates discussion state data displaying index values indicating a state of each discussion site; a user characteristic presentation unit which generates participating user characteristic data in relation to users participating in a discussion site specified by a user, the participating user characteristic data displaying index values indicating profiles of the users in a discussion; a user control unit which generates invitation nominated user data displaying an invitation nominated user appropriate for the discussion site specified by the user; and a display unit which displays the discussion state data, the participating user characteristic data, and the invitation nominated user data.

In the above-described discussion enlivenment assistance device, the state visualization unit may generate discussion state data displaying health degree, activeness degree, and freshness degree of each discussion site.

In the discussion enlivenment assistance device, the user characteristic presentation unit may generate participating user characteristic data in relation to users participating in a discussion site specified by the user, the participating user characteristic data displaying at least one of specialty degree of a category related to the specified discussion site and role degree of each role.

The above-described discussion enlivenment assistance device may further include an activeness degree calculation unit which calculates activeness degree of a discussion site using the total number of statements, the number of participating users, and an elapsed time at the discussion site.

The above-described discussion enlivenment assistance device may further include a role degree calculation unit which calculates role degree of each role of a given user at a discussion site using a plurality of index values representing characteristics of statements at the discussion site.

The above-described discussion enlivenment assistance device may further include role estimation models for each role which calculate role degree in response to input of a plurality of index values representing a characteristic of a given statement, the role degree indicating degree of the given statement serving a given role.

The above-described discussion enlivenment assistance device may further include a specialty degree calculation unit which calculates specialty degree of a given user in a given category based on frequency of statements belonging to the category.

In the above-described discussion enlivenment assistance device, the user control unit may generate exclusion nominated user data displaying an exclusion nominated user inappropriate for a discussion site specified by a user, and the display unit may display the exclusion nominated user.

In the above-described discussion enlivenment assistance device, the user control unit may calculate aptitude degree of a registered user for a discussion site specified by a user using health degree and activeness degree related to the specified discussion site, and specialty degree and role degree related to the registered user.

The above-described discussion enlivenment assistance device may further include a user aptitude degree estimation model which calculates aptitude degree in response to input of health degree and activeness degree related to a discussion site specified by a user, and specialty degree and role degree related to a registered user, the aptitude degree indicating degree of the registered user being appropriate for the specified discussion site.

In the above-described discussion enlivenment assistance device, the discussion state data may display a symbol which enables identification of health degree of a discussion site using colors, where activeness degree of the discussion site is represented on a first axis and freshness degree of the discussion site is represented on a second axis on a two-dimensional plane.

A discussion enlivenment assistance method according to the present invention includes: generating discussion state data displaying index values indicating a state of each discussion site; generating participating user characteristic data in relation to users participating in a discussion site specified by a user, the participating user characteristic data displaying index values indicating profiles of the users in a discussion; generating invitation nominated user data displaying an invitation nominated user appropriate for the discussion site specified by the user; and displaying the discussion state data, the participating user characteristic data, and the invitation nominated user data.

A computer-readable recording medium according to the present invention stores a computer program executing: generating discussion state data displaying index values indicating a state of each discussion site; generating participating user characteristic data in relation to users participating in a discussion site specified by a user, the participating user characteristic data displaying index values indicating profiles of the users in a discussion; generating invitation nominated user data displaying an invitation nominated user appropriate for the discussion site specified by the user; and displaying the discussion state data, the participating user characteristic data, and the invitation nominated user data.

Accordingly, the discussion enlivenment assistance device above can be realized with utilization of a computer.

According to the present invention, it is possible to contribute discussion enlivenment.

### BRIEF DESCRIPTION OF THE DRAWINGS

FIG. 1 is a block diagram showing a configuration of a discussion enlivenment assistance device according to an embodiment of the present invention.

FIG. 2 is a functional configuration diagram in a user usage stage according to the discussion enlivenment assistance device shown in FIG. 1.

FIG. 3 is a process flow chart in the user usage stage according to the discussion enlivenment assistance device shown in FIG. 1.

FIG. 4 is a functional configuration diagram in a preparation stage according to the discussion enlivenment assistance device shown in FIG. 1.

FIG. 5 is a process flow chart in the preparation stage according to the discussion enlivenment assistance device shown in FIG. 1.

FIG. 6 is a process flow chart of a role estimation model establishing process according to the embodiment of the present invention.

FIG. 7 is a process flow chart of a user characteristic DB establishing process according to the embodiment of the present invention.

FIG. 8 is a process flow chart of a user aptitude degree estimation model establishing process according to the embodiment of the present invention.

FIG. 9 is a configuration example of a discussion state data displaying screen according to the embodiment of the present invention.

FIG. 10 is a configuration example of an integrated display data displaying screen according to the embodiment of the present invention.

### DETAILED DESCRIPTION OF THE INVENTION

Hereunder, an embodiment of the present invention is described, with reference to the drawings.

First, the outline of the present embodiment is described.

### (Visualization of State of Each Discussion Site)

Whether or not a discussion is in conflict and whether or not it is active on each discussion site is visualized in order for a user to intuitively identify the situation. As a result, when a large number of sites with discussions being carried out are present, this contributes to a user easily finding a discussion site which is in an active state without being in conflict (Problem 1).

### (Presentation of Characteristic of User Participating in Discussion)

For each user who is making statements on a discussion site specified by a user, the degree of specialty of a category, to which the content of the discussion belongs, and the degree of each role served in the discussion (role degree) are calculated and presented. As a result, this makes it easy for a user to identify the profile of users already participating in the discussion, and it reduces the level of psychological burden for making a statement on the discussion site (Problem 2).

Examples of role definition (Role 1) to (Role 4) in a discussion are shown below.

(Role 1) Commentator: one that actively states an opinion with valid reasoning.

(Role 2) Troll (in other words, Vandal): one that disturbs progress of a discussion.

(Role 3) Moderator: one that moderates and summarizes opinions useful for assisting discussion enlivenment.

(Role 4) Information Provider: one that presents external sources such as publication and URL.

In the present embodiment, “commentator” and “troll” are essential. Here, “troll” means a person who deliberately sends a message to a discussion group on the Internet to make other people angry.

### (Presentation of Appropriate User for Discussion)

On a discussion site specified by a user, an appropriate user is determined and nominated as an invitee, an inappropriate user is determined and nominated to be excluded, and each nominee is presented. As a result, this contributes to invitation to a discussion site in which the user participates, another appropriate user who has potential to make a contribution to the discussion (Problem 3).

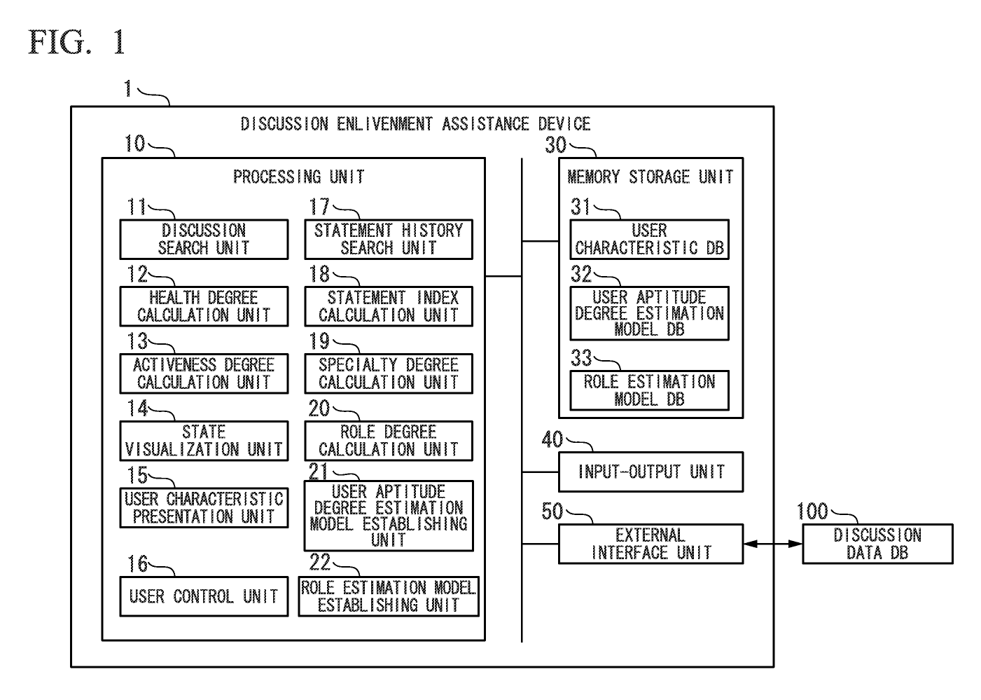

FIG. 1 is a block diagram showing a configuration of a discussion enlivenment assistance device 1 according to an embodiment of the present invention. In FIG. 1, the discussion enlivenment assistance device 1 includes a processing unit 10, a memory storage unit 30, an input-output unit 40, and an external interface unit 50. The processing unit 10 includes a CPU (central processing unit) and a memory, and has each unit for realizing functions thereof by executing, with the CPU, a program for realizing functions of the processing unit 10. Specifically, the processing unit 10 has a discussion search unit 11, a health degree calculation unit 12, an activeness degree calculation unit 13, a state visualization unit 14, a user characteristic presentation unit 15, a user control unit 16, a statement history search unit 17, a statement index calculation unit 18, a specialty degree calculation unit 19, a role degree calculation unit 20, a user aptitude degree estimation model establishing unit 21, and a role estimation model establishing unit 22.

The memory storage unit 30 includes a memory storage device such as hard disk device. The memory storage unit 30 stores a user characteristic database (user characteristic DB) 31, a user aptitude degree estimation model database (user aptitude degree estimation model DB) 32, and a role estimation model database (role estimation model DB) 33.

The input-output unit 40 includes an input device such as a keyboard and mouse, and a display device such as a liquid crystal display device. The input-output unit 40 performs data input from a user and data presentation to a user.

The external interface unit 50 includes a communication device which transmits and receives data to and from a device outside the discussion enlivenment assistance device 1. The external interface unit 50 reads discussion data from a discussion data database (discussion data DB) 100 present outside the discussion enlivenment assistance device 1.

The processing unit 10, the memory storage unit 30, the input-output unit 40, and the external interface unit 50 are connected with buses for example so as to be capable of data transmission between each other.

The discussion data DB 100 stores discussion data for each discussion site. The discussion data has discussion identification information for identifying a discussion site (for example, a thread identification number for identifying a thread on an electronic bulletin board) and all statements stated on the discussion site, and it is configured so that each statement can be distinguished.

In the present embodiment, for each discussion site, the discussion data DB 100 assigns one statement to one record, and stores all of the statements stated on the discussion site as discussion data. For example, for each thread on the electronic bulletin board, the discussion data DB 100 assigns one statement to one record, and stores all of the statements submitted (posted) to the thread as discussion data. Data included in one record are shown below as (A1) to (A8).

(A1) Theme name: theme name of discussion in which a statement is made.

(A2) Category name: category to which a discussion belongs, and a plurality of category names can be given.

(A3) User name: name for identifying a user that made a statement.

(A4) Statement date and time: date and time on and at which a statement is made.

(A5) Statement content: the content of a statement, being text data.

(A6) Role label: a label which represents a role in a discussion; this is given to some statements.

(A7) Invitation label: this is given to all statements made in a discussion by a user invited to the discussion by another user.

(A8) Exclusion label: this is given to all statements made in a discussion by a user targeted for exclusion in the discussion.

The discussion data may be data of a discussion carried out online or data of a discussion carried out offline.

Examples of data of a discussion carried out online include data of statements made on an electronic bulletin thread published on the Internet, and data of statements made on an SNS community. Examples of data of a discussion carried out offline include data of statements recorded in a face-to-face meeting carried out by people.

Hereunder, operations of the discussion enlivenment assistance device 1 shown in FIG. 1 are described separately in a user usage stage and a preparation stage.

### (User Usage Stage)

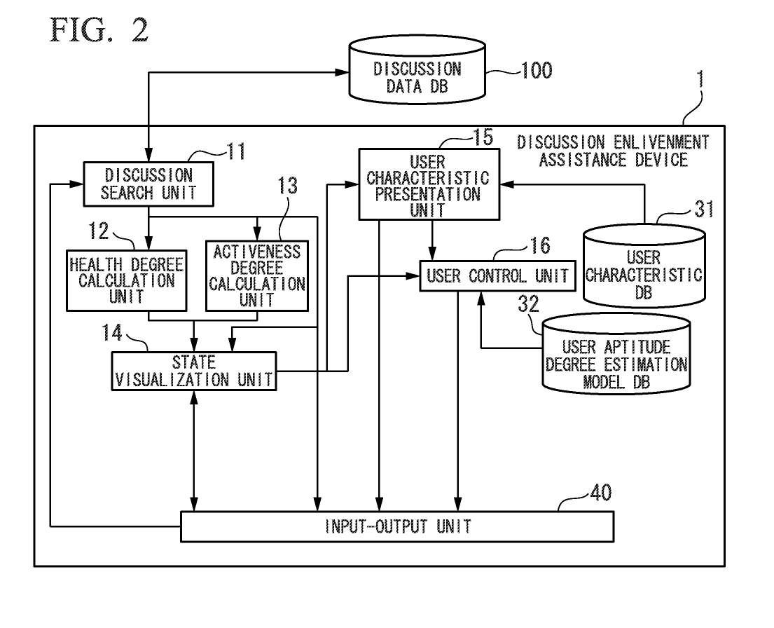

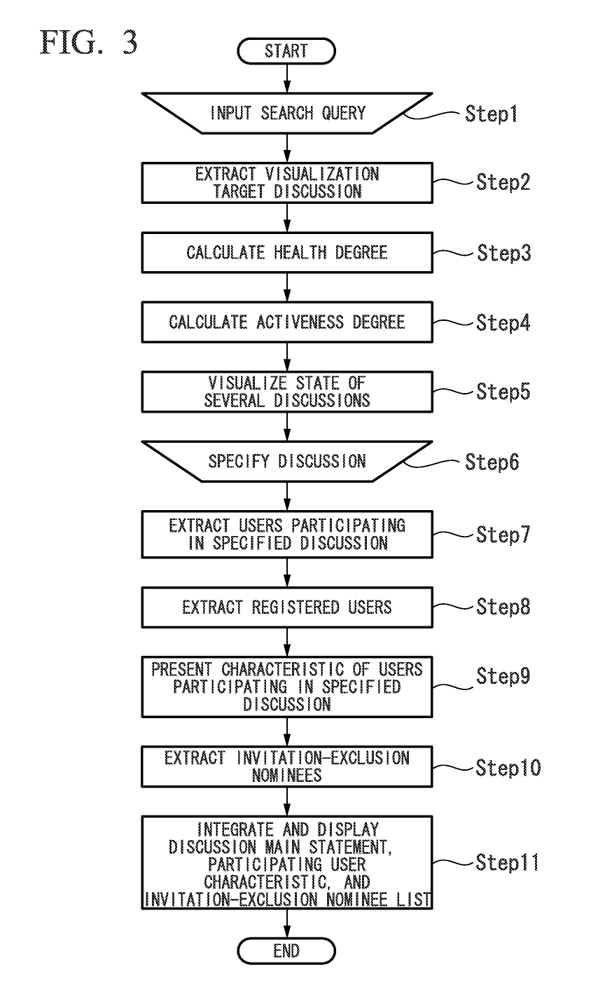

First, operations of the discussion enlivenment assistance device 1 in the user usage stage are described, with reference to FIG. 2 and FIG. 3. FIG. 2 is a functional configuration diagram in the user usage stage according to the discussion enlivenment assistance device 1 shown in FIG. 1. FIG. 3 is a process flow chart in the user usage stage according to the discussion enlivenment assistance device 1 shown in FIG. 1. The user usage stage is a stage in which a user uses the discussion enlivenment assistance device 1. Hereunder, an operation of each step is described, following the process flow shown in FIG. 3.

Step 1: The input-output unit 40 displays a search query input field on a display screen of a display device.

The input-output unit 40 configures the search query input field so that there can be entered a keyword which targets a theme name, a keyword which targets a statement content, and statement date and time which target the latest statement. As a result, discussion data containing the specified keyword in the theme name, discussion data containing the specified keyword in the statement content, and discussion data having the latest statement dated on and at the specified date and time and thereafter, can be searched. The user inputs a search query which indicates a condition of a discussion he or she wishes to find, into the search query input field displayed on the display screen. The input-output unit 40 outputs the search query input to the discussion search unit 11.

Step 2: The discussion search unit 11 performs a search on the discussion data DB 100 using the search query input from the input-output unit 40, and receives discussion data of the search result from the discussion data DB 100. The discussion search unit 11 outputs the search result discussion data to the heath degree calculation unit 12, the activeness degree calculation unit 13, the state visualization unit 14, and the input-output unit 40.

Step 3: The health degree calculation unit 12, for each discussion data, calculates a plurality of surface characteristic quantities of the discussion (such as the total number of statements, the number of participating users, the number of vocabularies, and statement interval time), and calculates the health degree of the discussion based on the calculated surface characteristic quantities. For this health degree calculation method, the commonly known method disclosed in Non-Patent Document 1 may be used. The health degree calculation unit 12, for each discussion data, outputs a combination of discussion identification information and discussion health degree to the state visualization unit 14.

Step 4: The activeness degree calculation unit 13 calculates the total number of statements C, the number of participating users P, and the elapsed time T for each discussion data, where C and P are natural numbers, and T is an integer not less than 0. The elapsed time T represents the number of elapsed days from the day on which the first statement is made to the day on which the latest statement is made. The activeness degree calculation unit 13 calculates the degree of activeness using the following formula for each discussion data.

Activeness degree={(C−P+1)×P}÷(1+T)

The activeness degree calculation unit 13, for each discussion data, outputs a combination of discussion identification information and discussion activeness degree to the state visualization unit 14.

Step 5: The state visualization unit 14 generates discussion state data for displaying index values (health (health degree), activeness (activeness degree), and freshness (freshness degree)) which indicate the state of each discussion site. More specifically, the state visualization unit 14 generates the discussion state data by using the combination of the discussion identification information and discussion health degree input from the health degree calculation unit 12, the combination of the discussion identification information and discussion activeness degree input from the activeness degree calculation unit 13, and the combination of the discussion identification information and the latest statement date and time (last updated date) of the discussion data input from the discussion search unit 11. Freshness of a discussion site (freshness degree) refers to temporal freshness of a statement on the discussion site. Last updated date in given discussion data refers to date and time on and at which the latest statement is made on the discussion site, and accordingly, it represents freshness (freshness degree) of the discussion site.

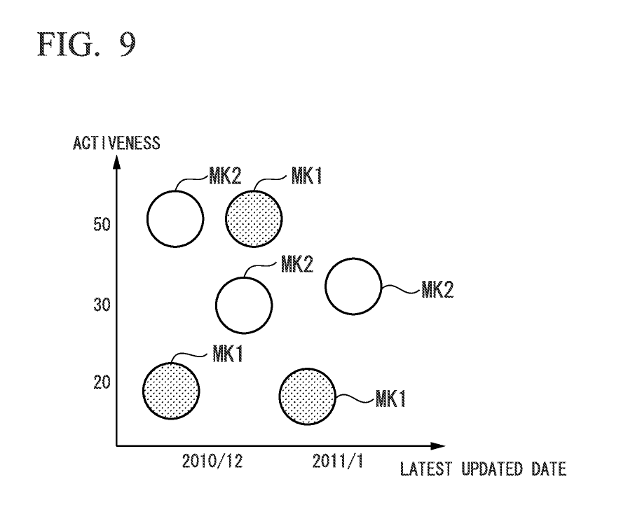

FIG. 9 is a configuration example of discussion state data according to the present embodiment being displayed on the display screen of the display device. The example of FIG. 9 shows a two-dimensional plane where the vertical axis represents activeness degree and the horizontal axis represents last updated date. The two-dimensional plane of FIG. 9 displays symbols MK1 and MK2 corresponding to the health degree related to respective discussion identification information in positions corresponding to activeness degree and last updated date related to the respective discussion identification information. As for the symbols corresponding to health degree, health degree may be identified with a difference in color, or health degree may be identified with a difference in contrast. In the example of FIG. 9, the symbol MK1 represents, based on the health degree, that the discussion site identified with the discussion identification information is in conflict. On the other hand, the symbol MK2 represents, based on the health degree, that the discussion site identified with the discussion identification information is not in conflict. The state visualization unit 14 outputs discussion state data to the input-output unit 40.

Step 6: The input-output unit 40 displays the discussion state data input from the state visualization unit 14 on the display screen of the display device. The user selects an arbitrary discussion site on the display screen of the discussion state data. The input-output unit 40 outputs the discussion identification information which identifies the discussion site selected by the user, to the state visualization unit 14. For example, in the discussion state data display example of FIG. 9, the user uses a pointing device such as a mouse to select an arbitrary symbol (symbol corresponding to health degree). Then the input-output unit 40 obtains the discussion identification information associated with the symbol selected by the user from the discussion state data, and outputs it to the state visualization unit 14.

Step 7: The state visualization unit 14 extracts the user name of all users from the discussion data corresponding to the discussion identification information input from the input-output unit 40, and generates a user name list. The state visualization unit 14 outputs the user name list and the category name of discussion data corresponding to the discussion identification information input from the input-output unit 40, to the user characteristic presentation unit 15. Moreover, the state visualization unit 14 outputs the health degree and activeness degree corresponding to the discussion identification information input from the input-output unit 40, and the user name list, to the user control unit 16.

Step 8: The user characteristic presentation unit 15, for each user name registered in a user characteristic DB 31, obtains user characteristic data corresponding to the user name from the user characteristic DB 31. The user characteristic DB 31 stores combinations of user name and user characteristic data. The user characteristic data has the specialty degree and role degree of each role in the discussion, for the user corresponding to the user name. The specialty degree is present for each category name, and the user characteristic presentation unit 15 obtains only the specialty degree which corresponds to the category name input from the state visualization unit 14.

The user characteristic presentation unit 15 obtains, for each category name, the specialty degree corresponding to the category name when there are a plurality of category names input from the state visualization unit 14.

Step 9: The user characteristic presentation unit 15 generates participating user characteristic data by using user characteristic data (specialty degree and role degree) corresponding to each user name. The generate participating user characteristic data is for displaying index values which indicate the image (user profile) of the participating users of the discussion site selected by the user in Step 6 (hereunder, referred to as specified discussion). The participating user characteristic data is described below.

First, the user characteristic presentation unit 15 generates specialty data having a combination of a user name and specialty degree, for each user name registered in the user characteristic DB 31. At this time, if there is a specialty degree for each of a plurality of category names, the user characteristic presentation unit 15 calculates the average value of the specialty degrees for each user name, to thereby generate specialty data having a combination of the user name and the specialty degree average value. Next, the user characteristic presentation unit 15 generates consolidated data having a combination of a user name, specialty degree, and role degree in a list format, for each user name registered in the user characteristic DB 31. Furthermore, the user characteristic presentation unit 15 generates participating user average characteristic data having the average characteristic, targeting user names listed on the user name list input from the state visualization unit 14. The average characteristic targets all of the user names listed on the user name list, and is the average value of the specialty degree for the respective categories, and the average value of the respective role degrees. On the user name list, there are listed user names of all users participating in the specified discussion.

The user characteristic presentation unit 15 outputs the participating user average characteristic data and the data related to the user names listed on the user name list in the consolidated data, to the input-output unit 40 as participating user characteristic data. Moreover, the user characteristic presentation unit 15 outputs the consolidated data to the user control unit 16. The participating user characteristic data may have data of either specialty degree or role degree.

Step 10: The user control unit 16 extracts data corresponding to the user name of a user nominated to be invited to the specified discussion (invitation nominated user) and data corresponding to the user name of a user nominated to be excluded from the specified discussion (exclusion nominated user), from the consolidated data. The method of selecting a nominated user is described below.

First, the user control unit 16 calculates the aptitude degree of each user with respect to the specified discussion, using the health degree and activeness degree input from the state visualization unit 14 (the health degree and activeness degree related to the specified discussion), the consolidated data input from the user characteristic presentation unit 15 (the specialty degree and role degree related to each user name registered in the user characteristic DB 31), and the user aptitude degree estimation model stored in the user aptitude degree estimation model DB 32. Next, if the aptitude degree calculated for a user not participating in the specified discussion is greater than a predetermined reference value α, the user control unit 16 selects this user as an invitation nominated user. The user not participating in the specified discussion is a user contained in the consolidated data, and is a user with a user name which is not listed on the user name list input from the state visualization unit 14. Next, if the aptitude degree calculated for a user participating in the specified discussion is smaller than a predetermined reference value p, the user control unit 16 selects this user as an exclusion nominated user. The user participating in the specified discussion is a user with a user name which is listed on the user name list input from the state visualization unit 14.

The user control unit 16 outputs, to the input-output unit 40, the data related to the invitation nominated user and the data related to the exclusion nominated user extracted from the consolidated data.

Step 11: The input-output unit 40 uses the discussion data of the specified discussion, the participating user characteristic data input from the user characteristic presentation unit 15, and the data related to the invitation nominated user (combination of user name, specialty degree, and role degree) and the data related to the exclusion nominated user (combination of user name, specialty degree, and role degree) input from the user control unit 16, to thereby generate integrated display data. The participating user characteristic data has, in a list format, participating user average characteristic data (the specialty degree average value for each category and the average value of respective role degrees related to all users participating in the specified discussion) and a combination of user name, specialty degree, and role degree of all users participating in the specified discussion.

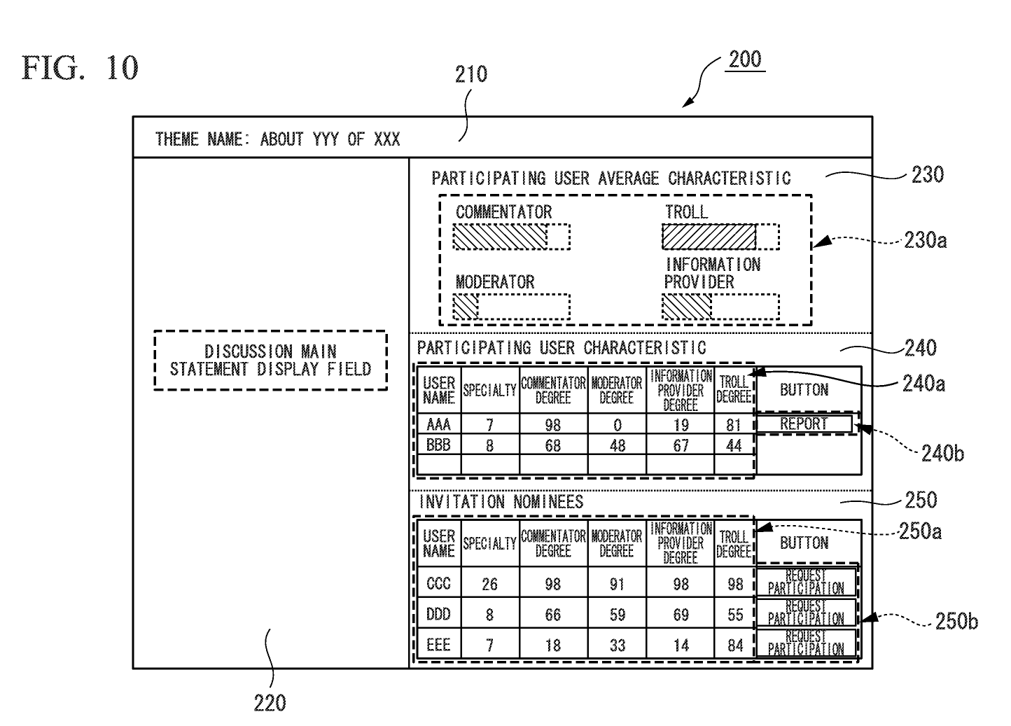

FIG. 10 is a configuration example of integrated display data according to the present embodiment being displayed on the display screen of the display device. In FIG. 10, the display screen 200 has a region 210 for displaying the theme name of the specified discussion, a region 220 for displaying statement contents in the discussion data of the specified discussion, and regions 230, 240, and 250 for displaying user related data.

The region 230 is a region for displaying the participating user average characteristic data in the participating user characteristic data. In the example of FIG. 10, the region 230 displays the average value of each role degree related to all users participating in the specified discussion (refer to block 230a). In this example, “commentator”, “moderator”, “troll”, and “information provider” are defined as roles in the discussion.

The region 240 is a region for displaying, in a list format, the combinations of user name, specialty degree, and role degree of users participating in the specified discussion (refer to block 240a). Moreover, if the user is an exclusion nominated user, the region 240 displays accordingly for each user name. Furthermore, if the user is an exclusion nominated user, a button for executing an action for the user (for example, “report”) is displayed (refer to block 240b).

The region 250 is a region for displaying, in a list format, the combination of user name, specialty degree, and role degree related to invitation nominated users (refer to block 250a). Furthermore, for each invitation nominated user, a button for executing a request for the user to participate in the specified discussion is displayed (refer to block 250b).

### (Preparation Stage)

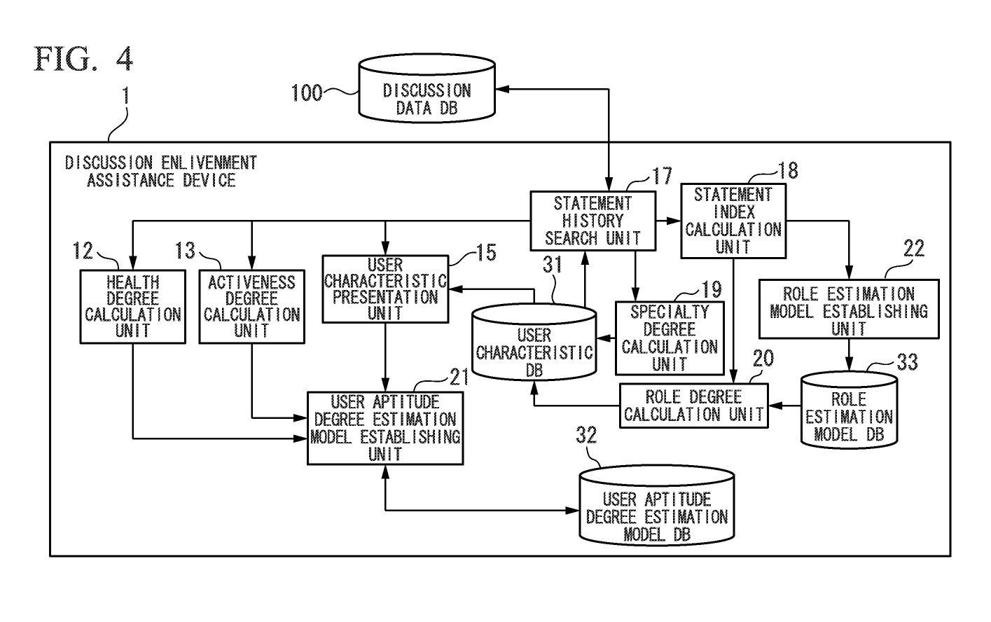

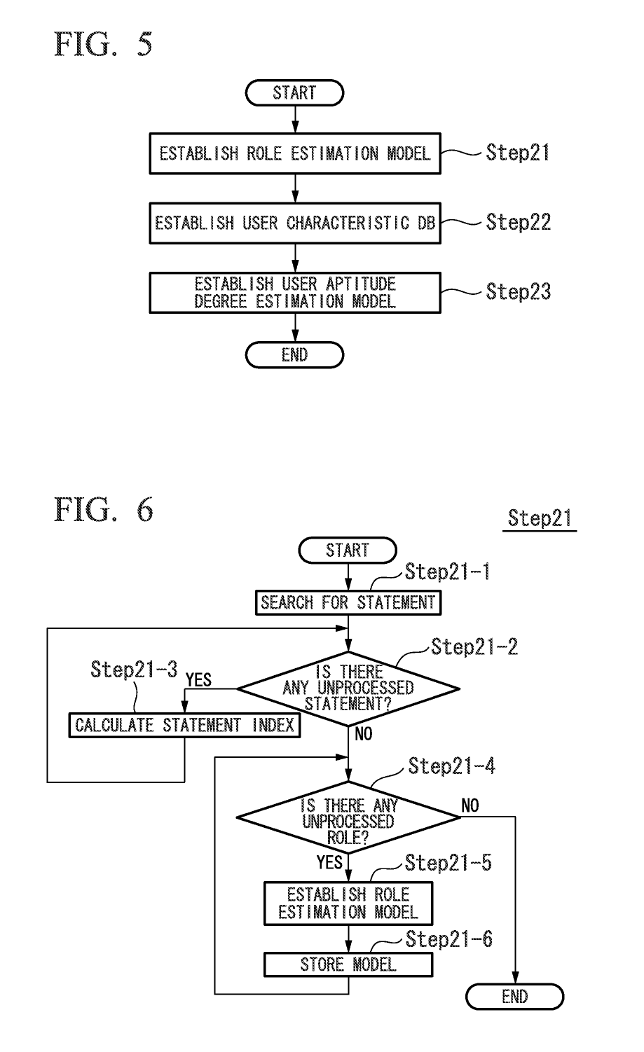

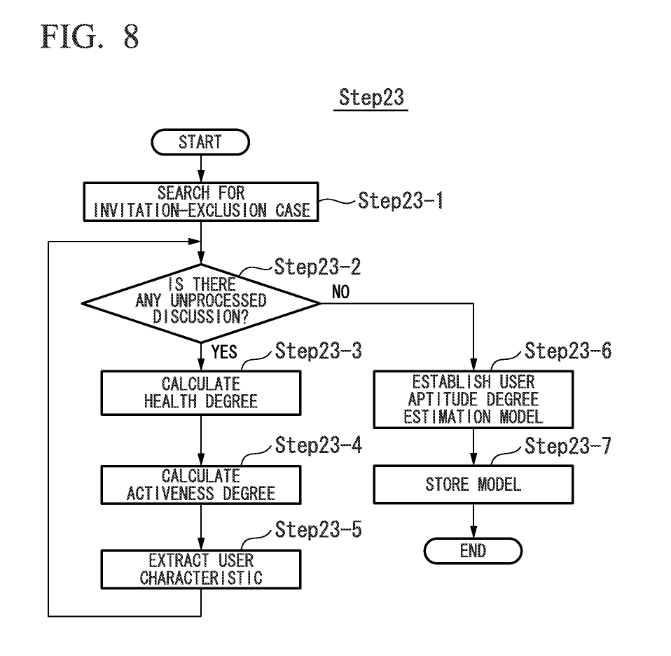

Next, operations of the discussion enlivenment assistance device 1 in a preparation stage are described, with reference to FIG. 4 and FIG. 8. FIG. 4 is a functional configuration diagram in the preparation stage according to the discussion enlivenment assistance device 1 shown in FIG. 1. FIG. 5 to FIG. 8 are process flow charts in the preparation stage according to the discussion enlivenment assistance device 1 shown in FIG. 1.

The preparation stage is executed before the user uses the discussion enlivenment assistance device 1.

In the preparation stage, as shown in FIG. 5, a role estimation model establishing process (Step 21), a user characteristic DB establishing process (Step 22), and a user aptitude degree estimation model establishing process (Step 23) are sequentially executed.

First, the role estimation model establishing process of Step 21 of FIG. 5 is described, with reference to FIG. 6. FIG. 6 is a process flow chart of the role estimation model establishing process according to the present embodiment.

The role estimation model is defined as a computation process in which when a plurality of index values which represent the characteristic of a statement or characteristic of statement content are input, there is calculated the degree of the statement content serving a role.

The role estimation model establishing unit 22 generates a role estimation model for each predefined role.

The role estimation model is stored in the role estimation model DB 33.

Step 21-1: The statement history search unit 17 obtains a statement record with a role label corresponding to any predetermined role given thereto, from the discussion data DB 100.

Here, it is assumed that Role 1 “commentator”, Role 2 “troll”, Role 3 “moderator”, and Role 4 “information provider” are preliminarily defined as roles in the discussion. The statement history search unit 17 outputs the statement record obtained from the discussion data DB 100, to the statement index calculation unit 18.

Step 21-2: The statement index calculation unit 18 determines whether, in the statement records input from the statement history search unit 17, there is still any statement record which has not undergone an index value calculation process. As a result, if there is any statement record which has not been processed, the process proceeds to Step 21-3. On the other hand, if all records have undergone the index value calculation process, the process proceeds to Step 21-4.

Step 21-3: The statement index calculation unit 18 calculates a plurality of (k) index values for each statement record input from the statement history search unit 17. Index values are defined as ones that represent the characteristics of a statement, and ones that represent the characteristics of statement content. Examples of index values (B1) to (B17) are shown below.

(B1) Number of characters: the number of characters contained in statement content.

(B2) Number of words: the number of words contained in statement content.

(B3) Number of vocabularies: the number of vocabularies contained in statement content.

(B4) Number of sentences: the number of sentences contained in statement content.

(B5) Number of question marks: the number of question marks “?” contained in statement content.

(B6) Number of exclamation marks: the number of exclamation marks “!” contained in statement content.

(B7) Imperative verb ratio: the ratio of verbs contained in statement content being imperative.

(B8) Number of new words: the number of words, among the words contained in the statement content, which appeared for the first time in the statement contents within the same discussion data.

(B9) Number of co-occurring words: the number of words, among the words contained in statement content, which also appeared in the statement content immediately therebefore (the statement content temporally one before within the same discussion).

(B10) Number of second persons: the number of second persons (such as “you”) that appeared in statement content.

(B11) Number of honorific prefixes: the number of expressions with honorific prefixes (such as “Mr” and “Ms”) that appeared in statement content.

(B12) Number of formal expressions: the number of formal expressions (such as “please”) that appeared in statement content.

(B13) Number of opinionative expressions: the number of expressions related to presence of opinions (such as “I think”, and “I believe”) that appeared in statement content.

(B14) Number of proposal expressions: the number of expressions related to the presence of proposals (such as “why don't you”, and “why don't we”) that appeared in statement content.

(B15) Number of user names: the number of user names of other users that appeared in statement content.

(B16) Number of external references: the number of links contained in statement content (such as link to external source, and URL).

The above index values from B1 to B16 represent statement characteristics, and further represent the characteristics of statement content.

(B17) Interval time: the interval time between the current statement and the one immediately therebefore. This interval time is an index value which represents statement characteristics.

When tallying the number of words and the frequency of imperative verbs, the statement index calculation unit 18 preliminarily performs morphological analysis on statement contents, and extracts words along with information of a part of speech and conjugation. The statement index calculation unit 18 outputs the plurality of (k) calculated index values to the role estimation model establishing unit 22 for each statement record related to Role O1. Then, the process returns to Step 21-2.

Step 21-4: The role estimation model establishing unit 22 determines whether there is still any role, among the predetermined roles, for which a role estimation model has not been generated. As a result, if there is still any role for which a role estimation model has not been generated, the process proceeds to Step 21-5. On the other hand, if a role estimation model has been generated for all of the predetermined roles, the role estimation model establishing process of FIG. 6 ends.

Step 21-5: The role estimation model establishing unit 22 generates a role estimation model for each role. The role estimation model establishing unit 22 generates Formula (1) as a role estimation model M (O1) of Role O1. Formula (1) is based on a multi-regression analysis method, which is one of the multivariate analysis methods.

$$\begin{matrix}( Formula 1 ) & \\ V ( O 1 ) = c + {\sum }_{i = 1}^{k} ai \times ei & ( 1 )\end{matrix}$$

Where, ‘V (O1)’ is an objective variable in the multi-regression analysis method, and represents the degree of a user serving Role O1 (role degree of Role O1), ‘ei’ is an explanatory variable in the multi-regression analysis method, and is the i-th index value among k index values (where ‘k’ is an integer not less than 2), ‘ai’ is a regression coefficient in the multi-regression analysis method, and is the degree of importance with respect to index value ei, and ‘c’ is a constant number.

The role estimation model establishing unit 22 receives inputs of several index values for each role and each statement record, from the statement index calculation unit 18. There are k index values for a single statement record. When generating the role estimation model M (O1) of Role O1, according to the multi-regression analysis, the role estimation model establishing unit 22 sets the objective variable V (O1) to a predetermined value for each statement record, and sets all (k) index values [e1, e2, . . . ek] to an explanatory variable, to thereby calculate k regression coefficients [a1, a2, . . . ak] and constant number c in Formula (1).

Here, the method of setting the objective variable V (O1) is described. When generating a role estimation model M (O1) of Role O1, the objective variable V (O1) related to the statement record with a role label corresponding to Role O1 given thereto is set to a value greater than the objective variable V (O1) related to the statement record with no role label corresponding to Role O1 given thereto. For example, the objective variable V (O1) related to the statement record with the role label corresponding to Role O1 given thereto is set to “100”, and the objective variable V (O1) related to the statement record with no role label corresponding to Role O1 given thereto is set to “0”.

In the present embodiment, the role estimation model is generated using a multi-regression analysis method, however, another multivariable analysis method or a machine learning method may be used to generate a role estimation model.

Step 21-6: The role estimation model establishing unit 22 stores the role estimation model in the role estimation model DB 33. Specifically, The role estimation model establishing unit 22 stores k regression coefficients [a1, a2, . . . ak] and constant number c in Formula (1), in the role estimation model DB 33. The role estimation model DB 33 maintains k regression coefficients [a1, a2, . . . ak] and constant number c for each role. Then, the process returns to Step 21-4.

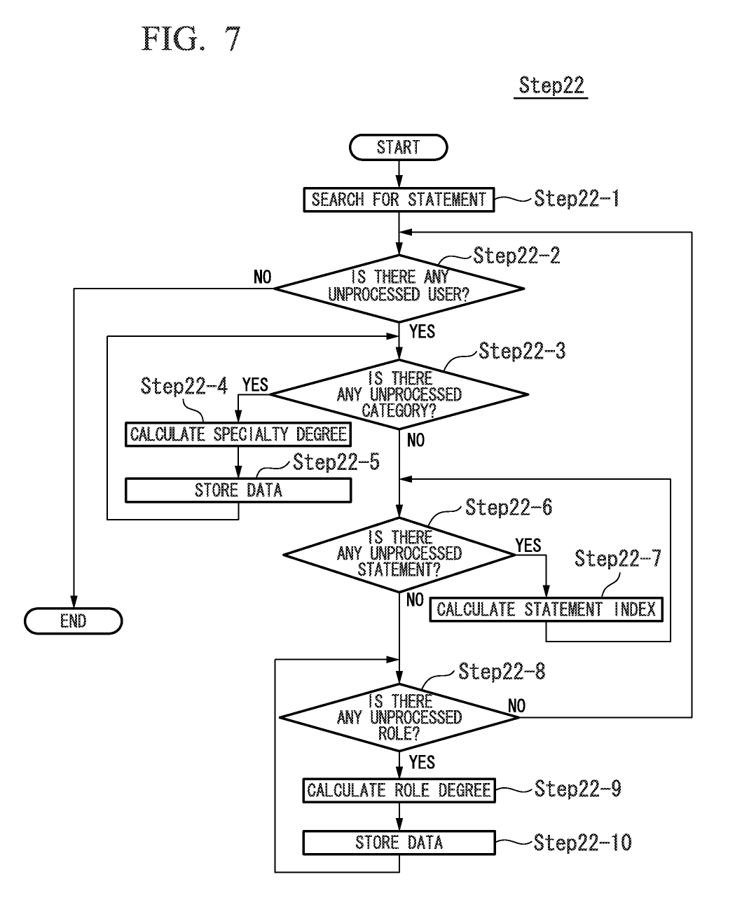

Next, the user characteristic DB establishing process of Step 22 of FIG. 5 is described, with reference to FIG. 7. FIG. 7 is a process flow chart of the user characteristic model establishing process according to the present embodiment.

The user characteristic DB 31 stores combinations of user name and user characteristic data. The user characteristic data has a specialty degree for each category and a role degree for each role, for the user corresponding to the user name. Specialty degrees are distinguished between category names. Role degrees are distinguished between role names.

Step 22-1: The statement history search unit 17 obtains all statement records of all user names registered in the user characteristic DB 31, from the discussion data DB 100.

The statement history search unit 17 outputs the statement record obtained from the discussion data DB 100, to the specialty degree calculation unit 19 and the statement index calculation unit 18.

Step 22-2: If the specialty degree calculation process and the role degree calculation process are completed for all user names registered in the user characteristic DB 31, the user characteristic DB establishing process of FIG. 7 ends. On the other hand, if the process is not completed yet, a category name list and statement record list are generated for the processing target, user name U, that has not been processed, and the process proceeds to Step 22-3.

The specialty calculation unit 19 extracts statement records of the user name U from all statement records input from the statement history search unit 17, and extracts category names from all statement records of the user name U, to thereby generate a list of names of categories in which the user name U made statements. With respect to all of the category names contained on the category name list of this user name U, there is initial-set an unprocessed flag. The statement index calculation unit 18 extracts statement records of the user name U from all statement records input from the statement history search unit 17, and creates a list of the statement records. With respect to all statement records contained on the statement record list of this user name U, there is initial-set an unprocessed flag.

Step 22-3: The specialty degree calculation unit 19 determines whether there is, on the category name list of the user name U, any category name with an unprocessed flag set thereto. As a result, if any is present, the process proceeds to Step 22-4. On the other hand, if there is none, the process proceeds to Step 22-6.

Step 22-4: With a category name A with an unprocessed flag set thereto on the category name list of the user name U, as the processing target, the specialty degree calculation unit 19 counts statement records of the category name A in all statement records input from the statement history search unit 17, and finds the total number of statement records N (A) of the category name A. Then, the specialty degree calculation unit 19 counts statement records of the user name U and of the category name A from all statement records input from the statement history search unit 17, and finds the total number of statement records NU (A) of the user name U and of the category name A. Next, the specialty degree calculation unit 19 uses the following formula to calculate the specialty degree of the category name A with respect to the user name U.

Specialty degree of category A related to user name U=NU(A)÷N(A)

Step 22-5: The specialty degree calculation unit 19 stores the specialty degree of the category name A related to the user name U in the user characteristic DB 31. After this, the unprocessed flag set to the category name A on the category name list of the user name U is released, and the process returns to Step 22-3.

Step 22-6: The statement index calculation unit 18 determines whether there is, on the statement record list of the user name U, any statement record with an unprocessed flag set thereto. As a result, if any statement record with an unprocessed flag set thereto is present, the process proceeds to Step 22-7. On the other hand, if there is none, the process proceeds to Step 22-8.

Step 22-7: With the statement record on the statement record list of the user name U, to which an unprocessed flag is set, as the processing target, the statement index calculation unit 18 calculates a plurality of (k) index values. These index values are similar to those calculated in Step 21-4 of FIG. 6. The statement index calculation unit 18 outputs the plurality of (k) calculated index values to the role degree calculation unit 20 for each statement record. After this, the unprocessed flag set to the processing target statement record on the statement record list of the user name U is released, and the process returns to Step 22-6.

Step 22-8: With respect to the user name U, the role degree calculation unit 20 determines whether there is still any role, for which a role degree has not been calculated yet, among the predetermined roles. As a result, if there is still any role for which a role degree has not been calculated, the process proceeds to Step 22-9. On the other hand, if a role degree has been calculated for all of the predetermined roles with respect to the user name U, the process returns to Step 22-2.

Step 22-9: With respect to the user name U, the role degree calculation unit 20 calculates the role degree of a single Role O, for which a role degree has not been calculated yet. First, the role degree calculation unit 20 obtains a role estimation model M (O) of Role O from the role estimation model DB 33. The role degree calculation unit 20 has received input of a plurality of (k) index values from the statement index calculation unit 18 for each statement record of the user name U. The role degree calculation unit 20, for each statement record of the user name U, inputs the plurality of (k) index values to the role estimation model M (O) of Role O as explanatory variables, to calculate objective variables V (O). Next, the role degree calculation unit 20 calculates the average value of the calculated objective variables V (O) related to all of the statement records. This average value is taken as a role degree of Role O related to the user name U.

Step 22-10: The role degree calculation unit 20 stores the role degree of Role O related to the user name U in the user characteristic DB 31. Then, the process returns to Step 22-8.

Next, the user aptitude degree estimation model establishing process of Step 23 of FIG. 5 is described, with reference to FIG. 8. FIG. 8 is a process flow chart of the user aptitude degree estimation model establishing process according to the present embodiment.

The user aptitude degree estimation model is defined as a computation process in which, when the health degree and activeness degree related to a specified discussion, and the specialty degree and role degree related to a user name are input, the degree of the user of the user name being appropriate for the specified discussion (aptitude degree) is calculated. The user aptitude degree estimation model establishing unit 21 generates a user aptitude degree estimation model. The user aptitude degree estimation model is stored in the user aptitude degree estimation model DB 32.

Step 23-1: The statement history search unit 17 searches the discussion data DB 100 for a statement record with an invitation label or exclusion label given thereto. Then, the statement history search unit 17 obtains discussion data, to which the statement record found in the search belongs, from the discussion data DB 100. The statement history search unit 17 pairs the user name of the statement record with an invitation label or exclusion label given thereto, and the discussion data to which the statement record belongs. Hereunder, this single pair is treated as a single invitation-exclusion case. The statement history search unit 17 outputs the invitation-exclusion case to the health degree calculation unit 12, the activeness degree calculation unit 13, and the user characteristic presentation unit 15.

Step 23-2: If the process of calculating the health degree and activeness degree, and the user characteristic extraction process have been completed for all invitation-exclusion cases, the process proceeds to Step 23-7. On the other hand, if these processes have not been completed, the unprocessed invitation-exclusion case CS is treated as a processing target, and the process proceeds to Step 23-3.

Step 23-3: The health degree calculation unit 12 calculates the health degree with respect to the discussion data of the invitation-exclusion case CS. The method of calculating this health degree is similar to that in Step 3 in the user usage stage of FIG. 3. The health degree calculation unit 12 outputs the health degree related to the invitation-exclusion case CS to the user aptitude degree estimation model establishing unit 21.

Step 23-4: The activeness degree calculation unit 13 calculates the activeness degree with respect to the discussion data of the invitation-exclusion case CS. The method of calculating this activeness degree is similar to that in Step 4 in the user usage stage of FIG. 3. The activeness degree calculation unit 13 outputs the activeness degree related to the invitation-exclusion case CS to the user aptitude degree estimation model establishing unit 21.

Step 23-5: The user characteristic presentation unit 15 obtains user characteristic data corresponding to the user name of the invitation-exclusion case CS, from the user characteristic DB 31. The user characteristic presentation unit 15 obtains the role degree of each role, from the obtained user characteristic data. Furthermore, the user characteristic presentation unit 15 obtains, from the obtained user characteristic data, the specialty degrees corresponding to all category names, and calculates the average value of the obtained specialty degrees. This average value is taken as the specialty degree related to the invitation-exclusion case CS. The user characteristic presentation unit 15 outputs the role degree of each role and the specialty degree related to the invitation-exclusion case CS to the user aptitude degree estimation model establishing unit 21. Then, the process returns to Step 23-2.

Step 23-6: The user aptitude degree estimation model establishing unit 21, with respect to all invitation-exclusion cases, receives input of the health degree, activeness degree, role degree of each role, and specialty degree, for each invitation-exclusion case. The user aptitude degree estimation model establishing unit 21 uses the input health degree, activeness degree, role degree of each role, and specialty degree, to thereby generate a user aptitude degree estimation model. This user aptitude degree estimation model generation process is similar to the role estimation model generation process in Step 21-5 of FIG. 6. The user aptitude degree estimation model establishing unit 21 generates a formula similar to Formula (1) as a user aptitude degree estimation model.

Here, as the method of setting the objective variable serving as an aptitude degree, the objective variable related to an invitation-exclusion case with an invitation label given thereto is set to a value greater than the objective variable related to an invitation-exclusion case with an exclusion label given thereto. For example, the objective variable related to the invitation-exclusion case with the invitation label given thereto is set to “100”, and the objective variable related to the invitation-exclusion case with the exclusion label given thereto is set to “0”.

Moreover, for explanatory variables, the health degree, activeness degree, role degree of each role, and specialty degree related to the invitation-exclusion case, are used for each invitation-exclusion case.

Step 23-7: The user aptitude degree estimation model establishing unit 21 stores the user aptitude degree estimation model in the user aptitude degree estimation model DB 32. After this, the user aptitude degree estimation model establishing process of FIG. 8 ends.

According to the embodiment described above, the effects described below can be obtained.

(1) The state of each discussion site (health, activeness, and freshness) is displayed as shown with the example in FIG. 9. As a result, a user can easily find a discussion site which is in an active state without being in conflict, without having to visually confirm statements on each discussion site.

(2) The characteristics (specialty degree of the category related to the specified discussion, and role degree of each role) of users participating in the specified discussion are displayed as shown with the example in FIG. 10. As a result, a user can first identify the profile of users participating in the discussion site (for example, whether reliable users participate in the discussion), and then participate in the discussion. Therefore, it is possible to reduce the level of psychological burden for the user to make a statement on the discussion site. Generally, it is easy to simply view a discussion. However, the level of psychological burden for a user to make a statement is considered high. This is particularly because it is difficult, due to the anonymous nature of discussions, to identify user characteristics, which would facilitate an understanding of a user profile (such as their specialty category and usual behavior) of the users already participating in the discussion. For example, if it is unclear whether any other user who specializes in the category is participating in the discussion, and if it is uncertain whether an appropriate response to a user's own statement can be obtained, the user may hesitate to make a statement in some cases. Further, in some cases, the user may not make a statement for fear of being targeted by another user who tends to attack other users. According to the present embodiment, it is possible to identify the user profile of users participating in a discussion site, and therefore, there can be expected an effect such that a sense of assurance is given to the user and statement making is promoted.

(3) Invitation nominated users related to the specified discussion are displayed as shown with the example in FIG. 10. As a result, the user can invite, to the specified discussion, an appropriate user who has a potential to make a contribution to the discussion. Accordingly, there can be expected an effect of enlivening a discussion site by inviting an appropriate user when the discussion site is not active. Moreover, the invited user can expect to be provided with a discussion site suitable for them.

The embodiment of the present invention has been described with reference to the drawings. However, the specific configuration is not limited to this embodiment, and various design changes may be made without departing from the scope of the invention.

Moreover, a program for realizing the respective steps shown in FIG. 3, FIG. 5, and FIG. 8 may be recorded on a computer-readable recording medium, and this program recorded on the recording medium may be loaded to and executed on a computer system, to thereby perform the discussion enlivenment assistance process. “Computer system” here may include an operating system and hardware such as peripheral devices.

Furthermore, the “computer system” here may include a home page provision environment (or home page display environment) in those cases where a WWW system is in use.

Moreover, the “computer-readable recording medium” here includes a memory storage device such as a flexible disk, a magnetic optical disk, a ROM, a writable non-volatile memory such as flash memory, a portable medium such as DVD (digital versatile disk), and a built-in hard disk in a computer system.

Furthermore, the “computer-readable recording medium” includes a medium which retains a program for a certain period of time, such as a volatile memory (DRAM (dynamic random access memory) for example) inside a computer system serving as a server or client in those cases where the program is transmitted via a network such as the Internet, or via a communication line such as a telephone line.

Moreover, the program above may be transmitted from a computer system with this program stored in a memory storage device or the like, to another computer system, via a transmission medium or transmission waves within the transmission medium. Here, the “transmission medium” for transmitting the program refers to a medium such as a network (communication network) such as the Internet and a communication line such as a telephone line, which has an information transmission function.

Furthermore, the program above may realize part of the function described above.

Moreover, the program may be a so-called difference file (difference program) capable of realizing the function described above by being combined with a program already recorded on a computer system.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A discussion enlivenment assistance device comprising:
a state visualization unit which generates discussion state data displaying index values indicating a state of each discussion site;
a user characteristic presentation unit which generates participating user characteristic data in relation to users participating in a discussion site specified by a user, the participating user characteristic data displaying index values indicating profiles of the users in a discussion;
a user control unit which generates invitation nominated user data displaying an invitation nominated user appropriate for the discussion site specified by the user; and
a display unit which displays the discussion state data, the participating user characteristic data, and the invitation nominated user data.

2. The discussion enlivenment assistance device according to claim 1, wherein the state visualization unit generates discussion state data displaying health degree, activeness degree, and freshness degree of each discussion site.

3. The discussion enlivenment assistance device according to claim 1, wherein the user characteristic presentation unit generates participating user characteristic data in relation to users participating in a discussion site specified by the user, the participating user characteristic data displaying at least one of specialty degree of a category related to the specified discussion site and role degree of each role.

4. The discussion enlivenment assistance device according to claim 2, further comprising
an activeness degree calculation unit which calculates activeness degree of a discussion site using the total number of statements, the number of participating users, and an elapsed time at the discussion site.

5. The discussion enlivenment assistance device according to claim 3, further comprising
a role degree calculation unit which calculates role degree of each role of a given user at a discussion site using a plurality of index values representing characteristics of statements at the discussion site.

6. The discussion enlivenment assistance device according to claim 5, further comprising
role estimation models for each role which calculate role degree in response to input of a plurality of index values representing a characteristic of a given statement, the role degree indicating degree of the given statement serving a given role.

7. The discussion enlivenment assistance device according to claim 3, further comprising
a specialty degree calculation unit which calculates specialty degree of a given user in a given category based on frequency of statements belonging to the category.

8. The discussion enlivenment assistance device according to claim 1,
wherein the user control unit generates exclusion nominated user data displaying an exclusion nominated user inappropriate for a discussion site specified by a user, and
the display unit displays the exclusion nominated user.

9. The discussion enlivenment assistance device according to claim 1, wherein the user control unit calculates aptitude degree of a registered user for a discussion site specified by a user using health degree and activeness degree related to the specified discussion site, and specialty degree and role degree related to the registered user.

10. The discussion enlivenment assistance device according to claim 9, further comprising
a user aptitude degree estimation model which calculates aptitude degree in response to input of health degree and activeness degree related to a discussion site specified by a user, and specialty degree and role degree related to a registered user, the aptitude degree indicating degree of the registered user being appropriate for the specified discussion site.

11. The discussion enlivenment assistance device according to claim 2, wherein the discussion state data displays a symbol which enables identification of health degree of a discussion site using colors, where activeness degree of the discussion site is represented on a first axis and freshness degree of the discussion site is represented on a second axis on a two-dimensional plane.

12. A discussion enlivenment assistance method comprising:
generating discussion state data displaying index values indicating a state of each discussion site;
generating participating user characteristic data in relation to users participating in a discussion site specified by a user, the participating user characteristic data displaying index values indicating profiles of the users in a discussion;
generating invitation nominated user data displaying an invitation nominated user appropriate for the discussion site specified by the user; and
displaying the discussion state data, the participating user characteristic data, and the invitation nominated user data.

13. A computer-readable recording medium which stores a computer program executing:
generating discussion state data displaying index values indicating a state of each discussion site;
generating participating user characteristic data in relation to users participating in a discussion site specified by a user, the participating user characteristic data displaying index values indicating profiles of the users in a discussion;
generating invitation nominated user data displaying an invitation nominated user appropriate for the discussion site specified by the user; and
displaying the discussion state data, the participating user characteristic data, and the invitation nominated user data.
